(19) United States
(12) Patent Application Publication
(10) Pub. No.: US 2014/0121867 A1
(43) Pub. Date: May 1, 2014

(54) METHOD OF CONTROLLING A HYBRID POWERTRAIN WITH MULTIPLE ELECTRIC MOTORS TO REDUCE ELECTRICAL POWER LOSSES AND HYBRID POWERTRAIN CONFIGURED FOR SAME

(71) Applicant: GM GLOBAL TECHNOLOGY OPERATIONS LLC, Detroit, MI (US)

(72) Inventors: Goro Tamai, West Bloomfield, MI (US); Anthony J. Corsetti, Rochester Hills, MI (US); Norman K. Bucknor, Troy, MI (US); Min-Joong Kim, Troy, MI (US)

(73) Assignee: GM Global Technology Operations LLC, Detroit, MI (US)

(21) Appl. No.: 13/665,964

(22) Filed: Nov. 1, 2012

(51) Int. Cl. B60W 10/08

(52) U.S. Cl. 701/22; 180/65.265; 180/65.22; 903/902

(57) ABSTRACT

A method includes determining a first electrical power loss value of operating first and second electric machines with power inverters of both electric machines in an active mode. The method includes determining at least one of a second and a third electrical power loss value. The second electrical power loss value is with operating with the power inverter of the first electric machine in the active mode and the power inverter of the second electric machine in a standby mode. The third electrical power loss value is with operating with the power inverter of the second electric machine in the active mode and the power inverter of the first electric machine in the standby mode. A controller sets the power inverters in the respective modes corresponding with a lowest of the electrical power loss values.

### TECHNICAL FIELD

The present teachings generally include a method of controlling a hybrid powertrain with multiple electric machines and a hybrid powertrain having multiple electric machines.

### BACKGROUND

Many hybrid vehicles utilize hybrid electric powertrains that have an engine and two or more electric machines, such as electric motor/generators, controlled to provide various operating modes. In some of the operating modes, only a relatively low torque, or zero torque, may be required from one or both of the electric machines. The energy required to operate a power inverter with electronic switches in an active mode, as required for converting between direct current and alternating current for a three-phase electric machine, and the spin losses associated with the rotating motor, assuming it is a permanent magnet motor, can be significant.

### SUMMARY

A method of controlling a hybrid powertrain allows power losses associated with an active power inverter and with rotating motor components to be reduced under certain operating conditions by placing the inverter in a standby mode, allowing the electric machine to be in a free-running state. The method includes determining a first electrical power loss value of operating both a first electric machine and a second electric machine with power inverters of both electric machines in an active mode. The method further includes determining at least one of a second electrical power loss value and a third electrical power loss value. The second electrical power loss value is the electrical power loss of operating with the power inverter of the first electric machine in the active mode and the power inverter of the second electric machine in a standby mode. The third electrical power loss value is the electrical power loss of operating with the power inverter of the second electric machine in the active mode and the power inverter of the first electric machine in the standby mode. The lowest of the first electrical power loss value and one or both of the second electrical power loss value and the third electrical power loss value is then determined. A control action is then executed with respect to the power inverters via a controller to set the power inverters in the respective modes corresponding with the lowest of the first electrical power loss value and the at least one of the second and the third electrical power loss values. By valuing electrical power losses associated with electrical machines and power inverters and controlling the electrical machines and power inverters accordingly, the fuel efficiency of the hybrid powertrain can be increased.

A hybrid powertrain that has a prime mover, such as an engine, and a hybrid transmission with at least two electric machines and a controller having a processor configured to execute a control algorithm that carries out the method is also included.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a motor power loss map showing motor power loss curves in kilowatts (kW) at different motor torques in Newton-meters (Nm) on the Y-axis and motor speeds in revolutions per minute (rpm) on the X-axis for a representative electric machine.

FIG. 2 is an inverter power loss map showing inverter power loss curves in kilowatts (kW) at different motor torques in Newton-meters (Nm) on the Y-axis and motor speeds in revolutions per minute (rpm) on the X-axis for a representative power inverter for the electric machine characterized by the motor power losses shown in FIG. 1.

FIG. 3 is schematic block diagram of a portion of a powertrain having an electric machine and a power inverter controllable according to the method illustrated in FIG. 12 and representative of any of the electric machines in the hybrid powertrains of FIGS. 4 and 6.

FIG. 4 is a schematic illustration of a vehicle with a first hybrid powertrain.

FIG. 5 is a plot of cumulative energy loss for a first electric machine of a representative hybrid powertrain, and for a second electric machine of the representative hybrid powertrain, both when the first electric machine is in a free-running state in which inverter switches of the first electric machine are in standby mode, and in a non-free-running state in which inverter switches of the first electric machine are in active mode.

FIG. 6 is a schematic illustration of a second vehicle with a second hybrid powertrain.

FIG. 7 is a plot of rear drive axle power versus front drive axle power for the powertrain of FIG. 6.

FIG. 8 is a schematic plot of vehicle speed, speed of a gear within the transmission, and vehicle acceleration versus time in seconds as the hybrid vehicle of FIG. 6 is subjected to a drive cycle.

FIG. 9 is schematic plot of engine power, mechanical power of a first electric machine, mechanical power of a second electric machine, battery power and vehicle tractive power versus time in seconds corresponding with the drive cycle of FIG. 8.

FIG. 10 is a schematic plot of engine torque, first electric machine torque, and second electric machine torque versus time in seconds corresponding with the drive cycle of FIG. 8.

FIG. 11 is a schematic plot of engine speed, speed of the first electric machine, and speed of the second electric machine, all in revolutions per minute (rpm) versus time in seconds corresponding with the drive cycle of FIG. 8.

FIG. 12 is a flowchart illustrating a method of controlling a hybrid powertrain to reduce electrical power loss.

### DETAILED DESCRIPTION

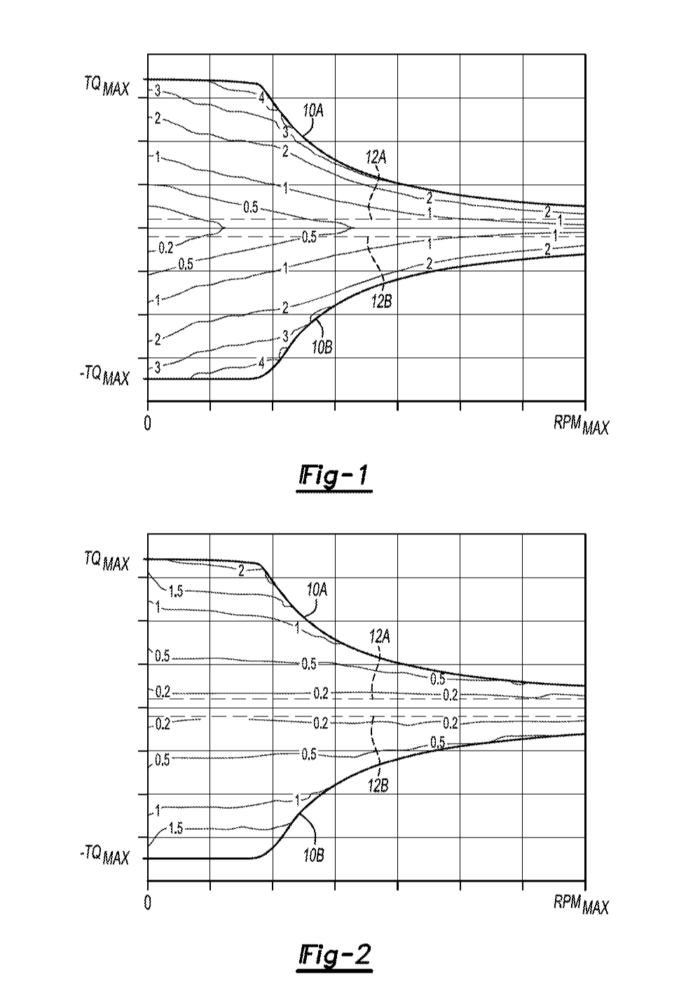

Referring to the drawings, wherein like reference numbers refer to like components throughout the several views, FIGS. 1 and 2 shows the typical electrical power losses of a representative electric machine and power inverter, respectively, of a hybrid powertrain. A method is provided herein, as described with respect to the flowchart of FIG. 12, of controlling a hybrid powertrain that has at least two electric machines by determining whether electrical power losses can be reduced by instead allowing either or both of the electric machines to be “free running” and the power inverter associated with the free-running electric machine to be set to a “standby mode”, both as further described herein.

FIG. 1 shows various motor power loss curves ranging from 0.2 to 4 kW between motor torque limit curves 10A and 10B in Newton-meters (Nm) versus speed in revolutions per minute (rpm) of an electric machine having a maximum torque capability TQ_{MAX} and a maximum speed RPM_{MAX}. FIG. 2 shows various inverter power loss curves ranging from 0.2 to 2 kW between motor torque limit curves 10A and 10B in Newton-meters (Nm) versus speed in revolutions per minute (rpm) of the electric machine. The power loss curves of FIGS. 1 and 2 are for an electric machine that is a permanent magnet electric machine.

FIGS. 1 and 2 illustrate that, even at relatively low motor torques, such as torques less than or equal to approximately 10 percent of the maximum motor torque capability TQ_{MAX}, indicated between a predetermined torque 12A, 12B, there are motor power losses and inverter power losses. If an electric machine is operating in the torque range at or between the predetermined torques 12A, 12B, the method of FIG. 10 an be implemented to determine whether system power losses (i.e., motor power losses and inverter power losses for two or more electric machines and associated inverters) can be reduced by allowing the electric machine operating at the relatively low torque to instead be free-running, with the inverter in standby mode.

An electric machine is “free-running” when it is not controlled to provide torque or generate electricity and no electrical power is running through the stator windings. The rotor of the electric machine may still be spinning in the free-running state, so spin losses associated with windage may still exist. Power losses associated with electrical power in the motor windings, for example, will be avoided.

A power inverter is in “standby mode” when the switches within the inverter that are used to convert between direct current supplied from or to a battery to alternating current required by or generated by an electric machine that has three phase windings are disabled. The switches are disabled by controlling them to remain open. During any period that the electric machine is free-running, the inverter operatively connected with the electric machine need not function to convert current. Operation of the switches during the free-running period is unnecessary, and power loss due to unnecessary switching within the inverter can thus be avoided if the power inverter is placed in the standby mode. In contrast, a power inverter is in “active mode” when its switches are controlled to open and close as required to convert between direct current and alternating current.

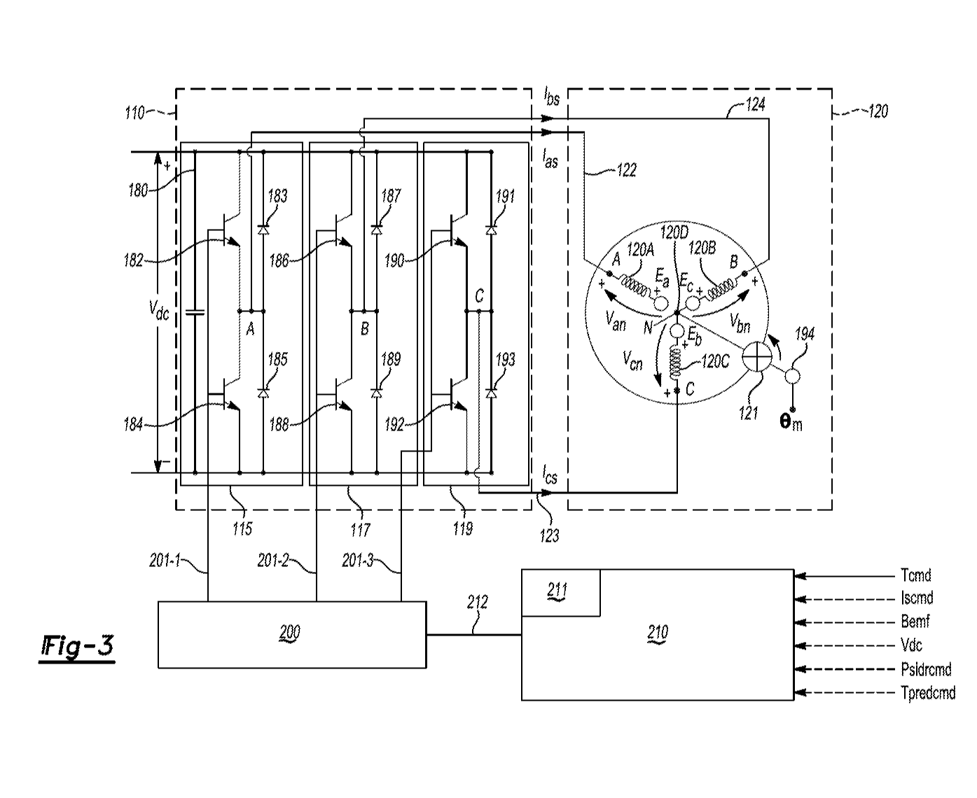

FIG. 3 is a schematic illustration of a portion of a hybrid powertrain including an inverter 110 connected to an electric machine 120. FIG. 3 illustrates a particular type of three-phase electric machine 120 that can be referred to as a star-connected (or Y-connected) three-phase electric machine 120, and the inverter 110 is a three-phase voltage source inverter module that can be referred to as a full-wave bridge inverter 110. It should be noted that the method of FIG. 12 is not limited to the inverter 110 and the electric machine 120 described in FIG. 3.

The electric machine 120 has three stator or motor windings 120A, 120B, 120C connected in a wye-configuration between motor terminals A, B, and C, and the three-phase inverter 110 that includes a capacitor 180 and three inverter sub-modules 115, 117, 119. In this embodiment, in phase A, the inverter sub-module 115 is coupled to motor winding 120A, in phase B, the inverter sub-module 117 is coupled to motor winding 120B, and in phase C, the inverter sub-module 119 is coupled to motor winding 120C. The motor windings A, B, C (120A, 120B, 120C) are coupled together at a neutral point (N) 120D. The current into motor winding A 120A flows out motor windings B 120B and C 120C, the current into motor winding B 120B flows out motor windings A 120A and C 120C, and the current into motor winding C 120C flows out motor windings A 120A and B 120B.

Phase currents (i.e., first stator current (Ias) 122, second stator current (Ibs) 123, and third stator current (Ics) 124) flow through respective stator windings 120A, 120B, and 120C. The phase to neutral voltages across each of the stator windings 120A-120C are respectively designated as Vₐₙ, V_{bn}, V_{cn}, with the back electromotive force (EMF) voltages generated in each of the stator windings 120A-120C respectively shown as the voltages Eₐ, E_{b}, and E_{c} represented by ideal voltage sources each respectively shown connected in series with stator windings 120A-120C. These back EMF voltages Eₐ, E_{b}, and E_{c} are the voltages induced in the respective stator windings 120A-120C by the rotation of a permanent magnet rotor driven by current in the stator windings 120A-120C. A rotor resolver 121 shown at a resolver position 194 senses rotor speed and rotor position angle θₘ of the rotor of the electric machine 120. The rotor of the electric machine 120 is coupled to a gearing arrangement or other portion of a hybrid transmission of a powertrain to add torque (when functioning as a motor) or convert torque to electrical power (when functioning as a generator).

The full-wave bridge inverter 110 includes a capacitor 180, a first inverter sub-module 115 comprising a dual switch (solid state switch 182, diode 183; solid state switch 184, diode 185), a second inverter sub-module 117 comprising a dual switch (solid state switch 186, diode 187; solid state switch 188, diode 189), and a third inverter sub-module 119 comprising a dual switch (solid state switch 190, diode 191; solid state switch 192, diode 193). Electronics within the full-wave bridge inverter 110 include six solid state switches 182, 184, 186, 188, 190, 192 and six diodes 183, 185, 187, 189, 191, 193 to appropriately switch DC input voltage (V_{dc}) and provide three-phase energization of the stator windings 120A, 120B, 120C of the three-phase AC electric machine 120.

A pulse width modulation (PWM) module 200 generates switching signals 201-1, 201-2, 201-3 for controlling the switching of solid state switches 182, 184, 186, 188, 190, 192 within the inverter sub-modules 115, 117, 119. By providing appropriate switching signals 201-1, 201-2, 201-3 to the individual inverter sub-modules 115, 117, 119, the PWM module 200 controls switching of solid state switches 182, 184, 186, 188, 190, 192 within the inverter sub-modules 115, 117, 119 and thereby controls the outputs of the inverter sub-modules 115, 117, 119 that are provided to motor windings 120A, 120B, 120C, respectively. The first stator current (Ias) 122, the second stator current (Ibs) 123, and the third stator current (Ics) 124 that are generated by the inverter sub-modules 115, 117, 119 of the three-phase inverter module 110 are provided to motor windings 120A, 120B, 120C. The voltages labeled as Vₐₙ, V_{bn}, V_{cn}, Eₐ, E_{b}, and E_{c} and the voltage at node N fluctuate over time depending on the open/close state of switches 182, 184, 186, 188, 190, 192 in the inverter sub-modules 115, 117, 119 of the inverter module 110, as will be described below.

In accordance with the disclosed embodiments, the controller 210 can generate disable or enable signals 212 to disable or enable switching within the inverter 110. For example, controller 210 can receive signals including a measured DC link or input voltage (V_{dc}), torque command (Tcmd) signals from the electric machine 120, stator current command (I_{scmnd}) signals or alternatively stator current command signals from a current mapping module, which are used to compute I_{scmd}, back EMF (Bemf) signals which may be computed from the stator current command signals, minimum flux preparation command (Psidrpreflux) signals, predicted torque command (T_{Predcmd}) signals and other operating signals. The controller 210 has a processor 211 that executes the method 1000 of FIG. 12, which is a stored algorithm in the processor 211, to reduce electrical power losses of the electric machines in the powertrain. Based on the signals described above, the controller 210 can calculate electrical power loss values of operating the electrical machines and inverters of the powertrain in free-running, active and standby modes, as described herein, and generate control signals 212 that are provided to the PWM module 200 to either enable or disable the PWM module 200, and thus effectively enable or disable the inverters of the powertrain, such as the inverter 110.

In one embodiment, the control signal 212 can be an enable signal that enables the PWM module 200 so that it generates switching signals 201-1, 201-2, 201-3 and thereby enables switching of the switches 182, 184, 186, 188, 190, 192 in the inverter 110, or a disable signal that disables the PWM module 200 so that it does not generate switching signals 201-1, 201-2, 201-3 and thereby disables switching of the switches 182, 184, 186, 188, 190, 192 in the inverter 110. By disabling switching of switches 182, 184, 186, 188, 190, 192 in the inverter 110 when no torque is commanded from the electric machine 120, gains in efficiency can be realized. For example, when the electric machine 120 is not being used (e.g., when no torque or torque less than a predetermined threshold torque is commanded or otherwise required), switches 182, 184, 186, 188, 190, 192 in the inverter 110 can effectively be disabled, i.e., placed in standby mode, thus eliminating the losses that would otherwise occur due to unnecessary switching within the inverter 110. In standby mode, there is still some power to the inverter 110, but it is greatly reduced in comparison to the power requirement to maintain the switches 182, 184, 186, 188, 190, 192 in active mode.

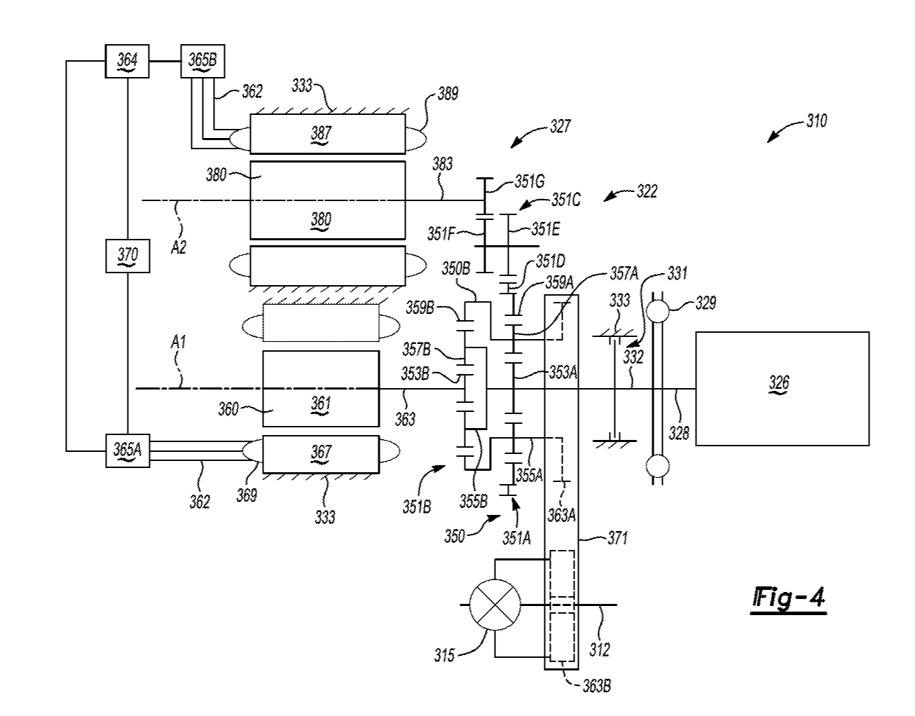

When the method of FIG. 12 is implemented to selectively set one or both electric machines in a hybrid powertrain to a free-running state and to selectively set one or both power inverters to the standby mode when the electric machines are in the free-running mode, significant electrical power losses can be avoided. Although the method can be applied to any hybrid powertrain that has two or more electric machines, for purposes of illustration, it is described with respect to a hybrid powertrain with an electrically-variable hybrid transmission shown in FIG. 4, and with respect to a hybrid powertrain shown in FIG. 7 that has one electric machine operatively connectable to a first drive axle, and a second electric machine operatively connectable to a second drive axle, referred to as a P1-P4 hybrid.

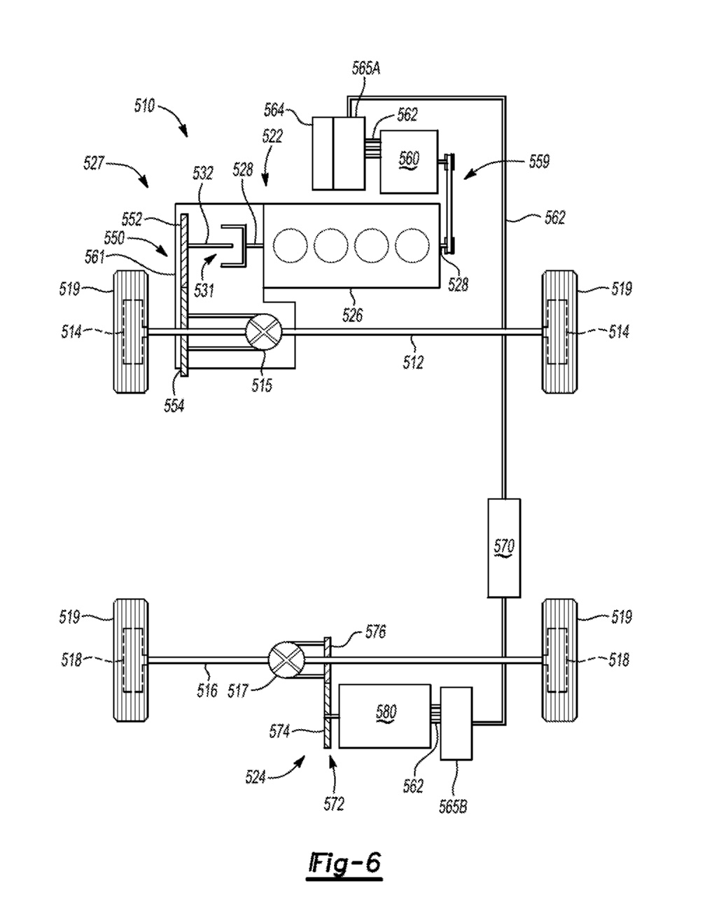

FIG. 4 shows an embodiment of a vehicle having a hybrid powertrain 327 with two electric machines 360, 380. As further described herein, any hybrid powertrain having multiple electric machines, including the powertrain 327 of FIG. 4 and the powertrain 527 of FIG. 6, can be controlled according to the method 1000 described herein and detailed in the flowchart of FIG. 12 to minimize the electrical power loss (and therefore minimizing the battery power used and increasing efficiency) by selectively placing power inverter switches in a standby mode.

FIG. 4 shows a vehicle 310 with a hybrid powertrain 327 that has a first electric machine 360, a second electric machine 380, and an engine 326. As used herein, an “engine” can be an internal combustion engine, or any other prime mover. An “electric machine” can be any electric motor that uses three-phase alternating current. An electric machine can be configured to be used as only a motor, as only a generator, or as both a motor and a generator in various embodiments within the scope of the invention.

The electric machines 360, 380 are interconnected through a gearing arrangement 350 as a hybrid electrically-variable transmission 322. An “electrically variable transmission” can be a transmission with a planetary gear set having one member operatively connected to an electric machine and another member operatively connected to an engine. The speed of the electric machine can be controlled to vary the speed of a third member of the planetary gear set to meet commanded torque requirements, allowing the engine to be operated at selected efficient parameters.

The electric machines 360, 380 can be controlled to function as motors or as generators and, with the engine 326, provide a variety of different operating modes under various operating conditions. The first electric machine 360 has a rotor 361 with a rotor shaft 363 rotatable about an axis A1, and a stator 367 with stator windings 369. The stator 367 is grounded to a stationary member 333, which can be the same stationary member to which a brake 331 is grounded, or a different stationary member, such as a motor housing. Cables 362 connect a power inverter 365A to the windings 369.

The second electric machine 380 has a rotor 381 with a rotor shaft 383 rotatable about an axis A2, and a stator 387 with stator windings 389. The stator 387 is grounded to a stationary member 333, which can be the same stationary member to which the brake 331 and the stator 367 are grounded, or a different stationary member, such as a motor housing. Cables 362 connect a power inverter 365B to the windings 389. The power inverters 365A, 365B are configured the same as described with respect to the power inverter 110 of FIG. 3.

A controller 364 is operatively connected to both power inverters 365A and 365B and to an energy storage device such as a battery 370 or battery module. The controller 364 controls the operation of the electric machines 360 and 380 as motors or as generators, and has a processor configured with an algorithm that carries out the method of minimizing power loss described with respect to FIG. 12. The controller 364 is operable as described with respect to the controller 210 of FIG. 3. That is, the controller 364 determines whether, during predetermined operating modes of the powertrain 327, the electrical power losses can be reduced by allowing either electric machine to free run, and by setting the switches of either power inverter 365A, 365B to the standby mode described with respect to the switches 182, 184, 186, 188, 190, 192 of FIG. 3.

The engine 326 has an engine crankshaft 328 connected through a damping mechanism 329 to an input member 332 of the transmission 322. A separate controller may be in communication with the controller 364 and control operation of the engine 326. An input brake 331 can be engaged to connect the input member 332 to a stationary member 333.

The gearing arrangement 350 includes two interconnected planetary gear sets 351A and 351B. The first planetary gear set 351A has a sun gear member 353A connected to rotate with the input member 332, a carrier member 355A supporting pinion gears 357A, and a ring gear member 359A. The pinion gears 357A mesh with the sun gear member 353A and the ring gear member 359A.

The second planetary gear set 351B has a sun gear member 353B connected to rotate with the rotor shaft 363 and meshing with pinion gears 357B supported on a carrier member 355B. The pinion gears 357B also mesh with a ring gear member 359B. The gearing arrangement 350 includes a transfer gear set 351C with transfer gears 351D, 351E, 351F and 351G that transfer torque between the rotor shaft 383 and the ring gear member 359A. The ring gear member 359B is continuously connected with the carrier member 355A and a pulley 363A by a connecting member 350B to rotate at the same speed. The carrier member 355B is continuously connected with the sun gear member 353A and the input member 332 to rotate at the same speed, or to be held stationary when the brake 331 is engaged. The pulley 363A rotates with the carrier member 355 and serves as an output member of the transmission 322, transferring torque through a belt 371 or chain to another pulley 363B which transfers torque to a drive axle 312 through a differential 315.

The hybrid powertrain 327 is controllable to operate in a variety of different operating modes selected by the controller 364 based on vehicle operating conditions. One such operating mode is an electrically-variable operating mode in which the engine 326 is on, and the first and second electric machines 360, 380 are controlled to operate as motors or as generators as required in order to vary the speed of the output member (pulley 363A) to meet operator requested torque at the drive axle 312. During the electrically-variable operating mode, it may be desirable to place either the first electric machine 360 or the second electric machine 380 in a free-running state, with the inverter 365A or 365B in a standby mode. For example, when the vehicle 310 is cruising, such as on the highway, with the first electric machine 360 spinning at a relatively low speed and the second electric machine 380 spinning at a relatively high speed, it may be desirable to slightly discharge or charge the battery 370 by a certain amount to remain within a predetermined range of states-of-charge of the battery 370. During this mode, it may be desirable to place the second electric machine 380 in the free-running state, with the switches of the inverter 365B in the standby mode, while operating the electric machine 360 as a motor using stored energy from the battery 370 or as a generator charging the battery 370, while still meeting required output torque.

The powertrain 327 is also operable in an electric-only operating mode with the engine 326 off and the input brake 331 engaged. Both electric machines 360 and 380 are controlled to operate as motors or as generators as needed to meet operator torque demand as long as the state-of-charge of the battery 70 remains above a predetermined minimum state of charge. During the electric-only operating mode, it may be desirable to place one of the electric machines 360 or 380 in the free-running state, with the inverter 365A or 365B in the standby mode, in order to reduce power losses while still meeting required output torque.

The powertrain 327 is also operable in an engine-off, regenerative mode, in which the engine 326 is off, and both electric machines 360 and 380 are controlled to operate as generators to slow the output member, pulley 363A, and thereby the drive axle 312. In the engine-off, regenerative mode, if either electric machine 360 or 380 is operating below a predetermined minimum threshold torque, it may reduce power losses to instead place that electric machine in a free-running state with the inverter in a standby mode, while still meeting required output torque.

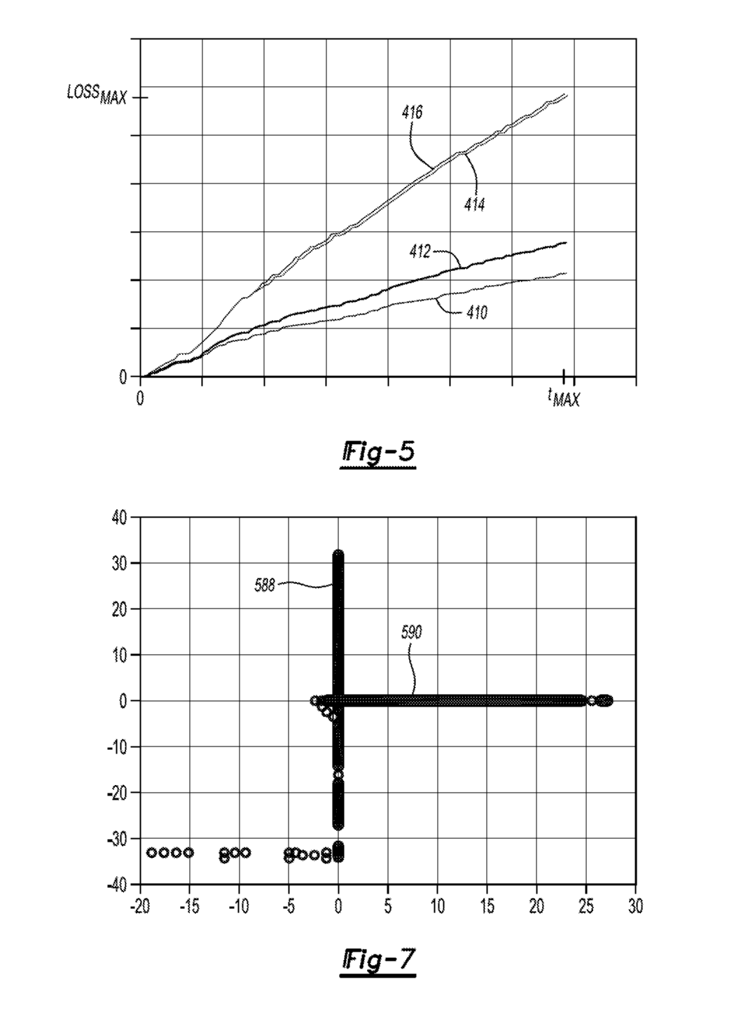

FIG. 5 shows an example of reduced power losses achieved during engine-off driving by placing one electric machine of an electrically-variable hybrid transmission like that of FIG. 4 in a free running state with the associated power inverter in standby mode. The cumulative energy loss in kilojoules (kJ) is illustrated on the Y-axis with time of operation of the powertrain in a typical city cycle in seconds on the X-axis with losses increasing as time increases to a maximum loss LOSS_{MAX} at the end of the test cycle t_{MAX}. Curve 410 is the cumulative power loss of one of the electric machines and its inverter when it is free-running and the inverter is in standby mode. Curve 412 represents the cumulative power loss of the same electric machine operating over the same city cycle but with its electric machine not free-running and with its inverter in an active mode (i.e., the inverter switches operating). Curve 416 shows the power losses in the second electric machine of the powertrain when the first electric machine is in the free-running state, and curve 414 shows the power losses of the second electric machine when the first electric machine is not free-running. Because the second electric machine is providing substantially all of the required output torque when the first electric machine is not free-running, as well as when the first electric machine is free-running, the effect of free-running the first electric machine on the power loss of the second electric machine and the second inverter is minimal.

Accordingly, if predetermined operating conditions are met, as discussed with respect to the method 1000 of FIG. 12, it is beneficial to control the first electric machine to operate in the free-running state and the inverter to be placed in standby mode. Specifically, in a range of torques less than a predetermined torque value (whether positive or negative), by instead allowing the electric machine to be free running (i.e., to receive or provide zero torque) and to accordingly allow the switches within the power inverter connected with the electric machine to be put in a standby mode, the power loss of the electric machine and of the inverter are reduced.

FIG. 6 schematically depicts a hybrid electric vehicle 510 having a first axle 512 connected to a first pair of wheels 514 and a second axle 516 connected to a second pair of wheels 518. In one embodiment, the wheels 514 are front wheels, and the wheels 518 are rear wheels. In FIG. 6, the wheels 514, 518 are shown with tires 519 attached. Each axle 512, 516 has two separate axle portions connected via a respective differential 515, 517 as is readily understood by those skilled in the art. The first axle 512 is connectable to a hybrid electric transmission 522, and the second axle 516 is connectable to an electric drive module 524. In the various operating modes described herein, the first drive axle 512 can be considered the output member of the powertrain 527 or the second drive axle 516 can be considered the output member of the powertrain 527. The hybrid electric transmission 522 includes an electric machine 560 and a mechanical transmission 561 that can have any gear arrangement. For example, in the embodiment shown, the transmission 561 is a simple gear set 550, but could instead by one or more planetary gear sets. The hybrid electric transmission 522, an engine 526, an energy storage device 570, a controller 564 operatively connected to a power inverter 565A, and the electric drive module 524 together establish a hybrid powertrain 527 that provides various operating modes for propulsion of the vehicle 510.

The hybrid electric transmission 522 is connected to the engine 526, which has an crankshaft 528. The hybrid electric transmission 522 includes an input shaft 532, the gear set 550, and the axle differential 515. The gear set 550 includes a first gear 552 and a second gear 554 that meshes with the first gear 552 and rotates commonly with a component of the differential 515, as is understood by those skilled in the art. The gear set 550 may instead be a chain engaged with rotating sprockets or a combination of mechanical elements instead of meshing gears. A disconnect clutch 531 can be used to disconnect the engine 526 from the transmission 522.

The first electric machine 560, is selectively operable as either a motor or as a generator, in different operating modes. The electric machine 560 has cables 562 that electrically connect it to a power inverter 565A. The first electric machine 560 includes a rotatable rotor and a stationary stator, arranged with an air gap between the stator and the rotor, as is known. However, for simplicity in the drawings, the first electric machine 560 is represented as a simple box. The electric machine 560 is connected to the crankshaft 528 by a belt drive system 559 that includes a belt and pulleys operable to transfer torque between a shaft of the electric machine 560 and the crankshaft 528.

A controller 564 is integrated with or separate but operatively connected with the power inverter 565A. The power inverter 565A converts alternating current provided by the first electric machine 560 to direct current that can be stored in an energy storage device 570, such as a propulsion battery, connected through additional cables 562 to the controller 564.

The electric drive module 524 includes a second final drive 572 that is a gear set having a first gear 574 and a second gear 576 meshing with the first gear 574 and the axle differential 517, one portion of which rotates commonly with the second gear 576, as is understood by those skilled in the art. The final drive 572, instead of a pair of meshing gears, may be a chain engaged with rotating sprockets or a planetary gear set or a combination of mechanical elements.

The electric drive module 524 also includes a second electric machine 580, which can be operable as a motor to propel the hybrid electric vehicle 510 or as a generator to assist in its propulsion or to provide or to assist in braking. The second electric machine 580 has cables 562 that electrically connect it to a power inverter 565B and the controller 564. The same controller 564 can be connected with the power inverter 565B or a separate controller that can be integrated with the power inverter 565B and in communication with the controller 564. The second electric machine 580 includes a rotatable rotor and a stationary stator, arranged with an air gap between the stator and the rotor, as is known. However, for simplicity in the drawings, the second electric machine 580 is represented as a simple box. The power inverter 565B converts direct current from the energy storage device 570 to alternating current for operating the second electric machine 580 and to convert alternating current from the electric machine 580 to direct current that can be stored in an energy storage device 570.

The hybrid powertrain 527 is sometimes referred to as a P1-P4 hybrid. It should be appreciated that, although a single controller 564 is illustrated and described as being operatively connected to both of the electric machines 560, 580 and to the engine 526, multiple different controllers, all configured to communicate with one another, may be dedicated to one or more of these components. In some embodiments, controller 564 may include an integrated power inverter to supply each electric machine 560, 580 with alternating current at a frequency corresponding to the operating speed of each electric machine, as is known. Controller 564 may be used to receive electrical power from the first electric machine 560 operating as a generator and to convey electrical power to the second electric machine 580 operating as a motor.

The hybrid powertrain 527 can be controlled by the controller 564 and a separate engine controller (not shown) that is in electrical communication with the controller 564 to operate in a variety of different modes to propel the vehicle. For example, the powertrain 527 can be operated in an engine-only mode if the disconnect clutch 531 is engaged, the electric machines 560, 580 are in a free-running mode, as discussed herein, and the engine 526 is on to propel the vehicle.

The hybrid powertrain 527 can be operated in an electric-only operating mode in which the disconnect clutch 531 is not engaged, the engine 526 is off, the first electric machine 560 is off, and the second electric machine 580 is controlled to operate as a motor, using electrical power stored in the battery 570, to power the vehicle.

The hybrid powertrain 527 can be operated in a series operating mode in which the engine is on and powers the first electric machine 560, which functions as a generator to power the second electric machine 580, which functions as a motor, providing tractive torque at the drive axle 516 and rear wheels 518.

The hybrid powertrain 527 can be operated in an engine-off, regenerative operating mode, in which the electric machine 560 is off or is in a free-running mode, the electric machine 580 is controlled to function as a generator, converting torque of the drive axle 512 into electrical energy stored in the battery 570.

The hybrid powertrain 527 is operable in an engine-on, battery charge/discharge mode in which the first electric machine 560 is controlled to operate as a motor or as a generator as necessary to meet a commanded drive torque (i.e., torque at the drive axle 512) while allowing the engine 526 to operate at its most efficient operating parameters. During this operating mode, the second electric machine 580 can be coasting, with the inverter 565B in a standby mode. A variety of additional operating modes are also available in which the hybrid powertrain 527 can be operated.

FIG. 7 is a plot of rear drive axle power versus front drive axle power for the powertrain of FIG. 6 during a highway drive cycle. Specifically, FIG. 7 shows the power in kilowatts provided by the second electric machine 580 at the rear axle 516 on the Y-axis in relation to the power in kilowatts at the front axle 512, shown on the X-axis. It FIG. 7 illustrates that there is a marked distinction between when rear axle power is demanded, indicated by the section 588 of the plot, versus when front axle power is demanded, indicated by the section 590 of the plot. Accordingly, because rear axle power is not required when front axle power is positive (forward propulsion) during the drive cycle, unless in an electric all-wheel drive mode, there is an opportunity for a reduction in power losses by allowing the rear electric machine 580 to be placed in a free-running state and to place the switches in the power inverter 565B in a standby mode.

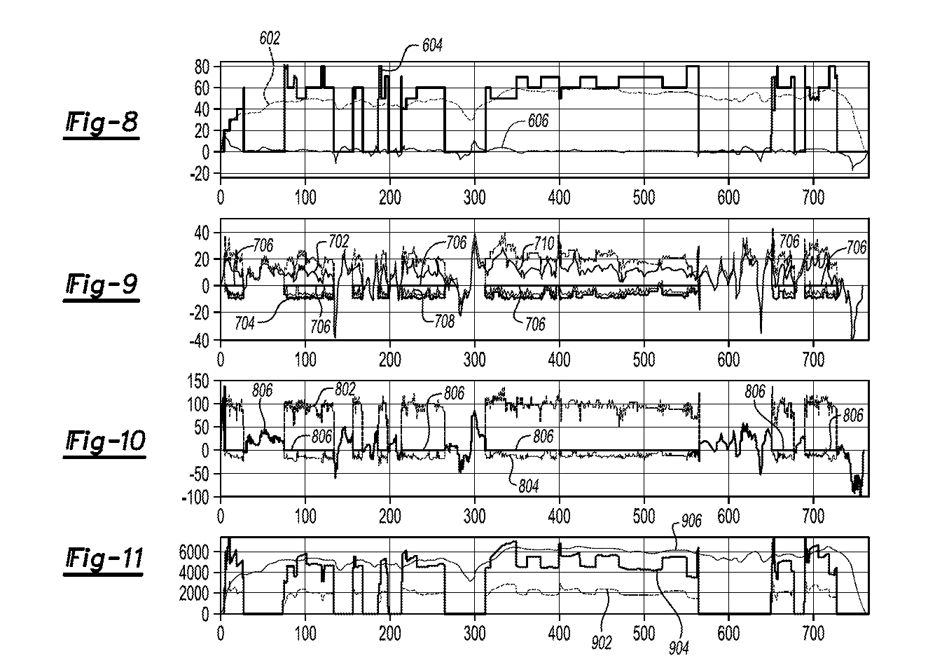

An example of the opportunities for power loss reduction during a highway drive cycle of the hybrid powertrain 527 is evident in the plots of FIGS. 8-11. FIG. 8 shows a schematic plot of vehicle speed 602, speed 604 of a gear within the transmission 561 multiplied by a factor of 10, and vehicle acceleration 606, versus time in seconds as the hybrid vehicle 510 is subjected to a drive cycle.

FIG. 9 is schematic plot of engine power 702 in kilowatts, mechanical power 704 of a first electric machine such as the front electric machine 560 in kilowatts, mechanical power 706 of a second electric machine such as the rear electric machine 580 in kilowatts, battery power 708 of battery 570 in kilowatts, and vehicle tractive power 710 versus time in seconds corresponding with the drive cycle of FIG. 8.

FIG. 10 is a schematic plot of torque 802 of the engine 526 in Nm, torque 804 of the front electric machine 560 in Nm, and torque 806 of the rear electric machine torque 580 versus time in seconds corresponding with the drive cycle of FIG. 8. In FIGS. 9 and 10, it is clear that power commanded from the rear electric machine 580 and associated torque of the rear electric machine 580 is frequently zero (see curves 706 and 806, with bolded portions of the zero power axis and zero torque axis indicating the electric machine 580 is not adding torque.

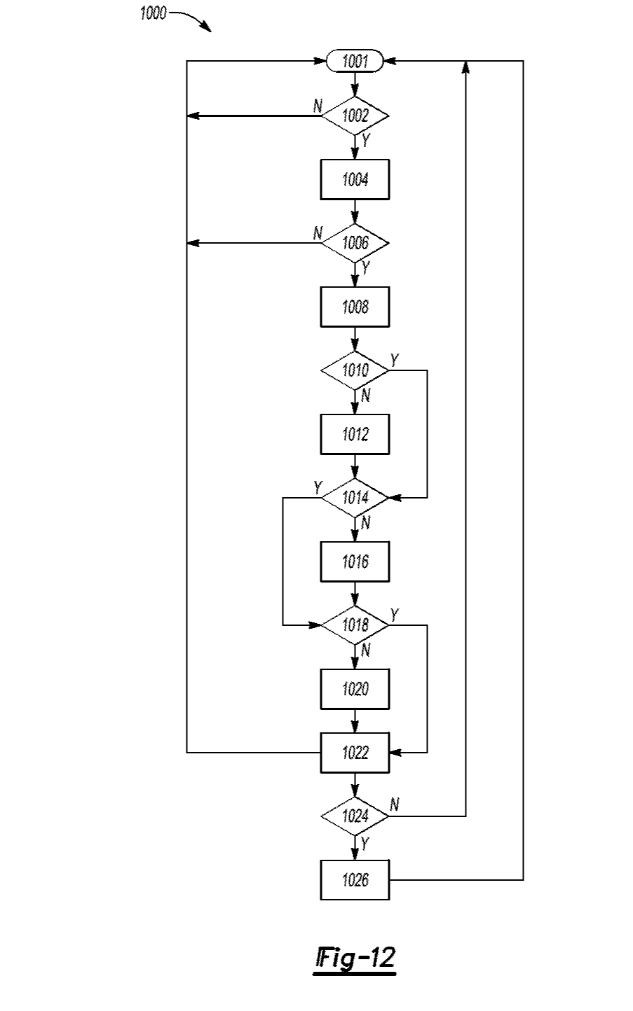

FIG. 11 indicates the speed 802 in rpm of the engine 526, the speed 904 in rpm of the front electric machine 560, and the speed 906 in rpm of the rear electric machine 580 versus time in seconds during the drive cycle. A comparison of FIGS. 9, 10, and 11 reveals that when the electric machine 580 is not powered and not contributing tractive torque during the drive cycle, it also has relatively high speed. Accordingly, there may be an opportunity for power savings by placing the electric machine 580 in a free-running state with the inverter 565B in a standby mode according to the method 1000 of FIG. 12.

The method 1000 of reducing power losses in a hybrid powertrain is shown in FIG. 12 and is described with respect to both the hybrid powertrains 327 and 527 of FIGS. 4 and 6, respectively. It should be appreciated, however, that the method 1000 can be utilized to reduce power losses on any hybrid powertrain that has two or more electric machines. The method 1000 is an algorithm carried out by a controller, such as the controller 210 of FIG. 3, the controller 364 of the powertrain 327 in FIG. 4, or the controller 564 of the powertrain 527 in FIG. 6, but is not limited to these powertrains. The controller 364 or 564 includes a processor that executes the algorithm.

The method 1000 starts at block 1001 when the vehicle is running, and begins with step 1002, described with respect to the powertrain 327 in step 1002 in the controller 364 determines whether the powertrain 327 is operating in a predetermined operating mode. For the powertrain 327, the operating mode must be one for which it has been determined that there may be a possibility of placing one of the electric machines 360, 380 in the free-running state with its associated power inverter 365A or 365B in a standby mode. For the powertrain 327, this can include an electric-only operating mode, in which the engine 326 is off and one or both electric machines 360, 380 are functioning as motors or generators. The predetermined operating mode can also be an engine-off, regenerative operating mode, in which the engine 326 is off and at least one of the electric machines 360, 380 is functioning as a generator to regenerate braking energy. Additionally, the predetermined operating mode can be an engine-on, battery charge or discharge mode, such as when the engine 326 is on and the vehicle is cruising, with rotor 361 of electric machine 360 spinning at low speed and the rotor 381 of electric machine 380 spinning at high speed to charge the battery 370 to a maximum state-of-charge, and then utilize stored battery power and discharge the battery to a minimum state-of-charge.

With respect to the powertrain 527, the predetermined operating mode of step 1002 can be an electric-only operating mode in which the engine 526 is off and the electric machine 580 functions as a motor to provide propulsion torque. The predetermined operating mode can also be an engine-off, regenerative operating mode, in which the engine 526 is off and at least one of the electric machines 560, 580 is functioning as a generator to regenerate braking energy. The predetermined operating mode can also be an engine-on battery discharge/charge mode in which the engine 526 is on, and in which the electric machine 560 is controlled to operate as a motor or as a generator as necessary to meet a commanded drive torque while allowing the engine 526 to operate at its most efficient operating parameters

If the controller 364 determines in step 1002 that the powertrain 327 is not in one of the predetermined operating mode(s), then the method 1000 returns to the start 1001 and repeats step 1002 after a predetermined time period. Similarly, if the controller 564 determines that the powertrain 527 is not in one of the predetermined operating mode(s), the method 1000 returns to the start 1001 and repeats step 1002 after a predetermined time period.

Step 1002 can include a sub step of counting the time that a given torque is commanded from the electric machines 360, 380 or 560, 580 to satisfy a predetermined output torque request to ensure that the given torque is commanded for at least a predetermined period of time before proceeding with the determinations of power loss values in steps 1008-1022, thereby reducing processor throughput if the electric machines 360, 380 or 560, 580 are not operating in a sufficiently steady operating state.

If the controller 364 determines in step 1002 that the powertrain 327 is in one of the predetermined operating modes, then the method 1000 proceeds to step 1004 in which the controller 364 determines the torque commanded from the first electric machine 360 and the torque commanded from the second electric machine 380 in order to satisfy a commanded output torque request. This determination can be based on vehicle operating parameters that can be determined by sensors, such as vehicle speed and acceleration. Similarly, for the powertrain 527, the controller 564 determines the torque commanded from the first electric machine 560 and from the second electric machine 580 to satisfy a predetermined output torque request.

Next, in step 1006, the controller 364 determines whether the torque commanded from either electric machine 360 or electric machine 380 is less than a predetermined threshold torque, such as a torque value between lines 12A and 12B of FIG. 1. Similarly, in the powertrain 527 of FIG. 6, the controller 564 determines in step 1006 whether the torque commanded from either the first electric machine 560 or the second electric machine 580 is less than a predetermined threshold torque. If the torque commanded is not less than the predetermined threshold torque, the method 1000 returns to the start 1001.

However, if the torque commanded from one or both electric machines 360, 380 of the powertrain 327, or one or both electric machines 560, 580 of the powertrain 527, the method 1000 moves on to determinations of various opportunities for power loss reductions. Step 1006 can include a sub step of starting a timer to determine that the torque commanded from one of the electric machines 360, 380 or 560, 580 is below the predetermined threshold value for at least a predetermined time period before proceeding with the determinations of power loss values in steps 1008-1022, thereby reducing processor throughput if the electric machines 360, 380 or 560, 580 are not operating in a sufficiently steady operating state.

In step 1008, the controller 364 determines a first electrical power loss value of operating with switches of the power inverters 365A, 365B in an active mode, as described with respect to the switches 182, 184, 186, 188, 190, and 192 of the inverter 110 of FIG. 3. The controller 564 makes a similar determination with respect to the first electric machine 560 and the second electric machine 580 when the controller 564 executes an algorithm that carries out the method 1000 for the powertrain 527. With the switches of both power inverters 365A, 365B or 565A, 565B in an active mode, the electric machines 360, 380 or 560, 580 will not be in a free-running state.

Next, in step 1010, the controller 364 or 564 determines whether vehicle operating parameters are such that it would be prohibitive to place the second power inverter 365B or 565B in a standby mode. This determination may be made from a stored look up table of operating parameters and associated ability to operate with the second power inverter in standby mode, or may be based on real time calculations of the ability to meet commanded torque at an output member if the second power inverter 365B or 565B is in standby mode and using current operating parameters. Vehicle operating parameters may be such that the commanded output torque cannot be met without operating the electric machine 380 or 580 to produce or require at least some torque, in which case it would be prohibitive for the associated power inverter 365B or 565B to be in the standby mode. If it is determined in step 1010 that it would be prohibitive to place the second power inverter 365B or 565B in a standby mode, then the method 1000 proceeds to step 1014. Otherwise, if it would not prohibitive to place the second power inverter 365B or 565B in the standby mode, then the method 1000 proceeds to step 1012, where the controller 364 or 565 determines a second electrical power loss value of operating the first power inverter 365A or 565A in the active mode, and the second power inverter 365B or 565B in the standby mode. By skipping step 1012 when it has already been determined that vehicle operating parameters would not permit placing the second power inverter 365B or 565B in the standby mode, processor throughout required to carry out the method 1000 is reduced.

In step 1014, the controller 364 or 564 determines whether vehicle operating parameters are such that it would be prohibitive to place the first power inverter 365A or 565A in a standby mode. This determination may be made from a stored look up table of operating parameters and the associated ability to operate with the first power inverter in standby mode, or based on real time calculations of the ability to meet commanded torque at an output member of the powertrain 327 or 527 if the first power inverter 365A or 565A is in standby mode and using current operating parameters. Vehicle operating parameters may be such that the commanded torque cannot be met without operating the first electric machine 360 or 560, in which case it would be prohibitive for the associated power inverter 365A or 565A to be in the standby mode.

If it is determined in step 1014 that it would be prohibitive to place the first power inverter 365A or 565A in a standby mode, then the method 1000 proceeds to optional step 1018. Otherwise, if it would not prohibitive to place the first power inverter 365A or 565A in the standby mode, then the method 1000 proceeds to step 1016, where the controller 364 or 565 determines a second electrical power loss value of operating the first power inverter 365A or 565A in the standby mode, but with the second power inverter 365B or 565B in the active mode. By skipping step 1016 when it has already been determined that vehicle operating parameters would not permit placing the first power inverter 365A or 565A in the standby mode, processor throughout required to carry out the method 1000 is reduced.

In optional step 1018, the controller 364 or 564 determines whether vehicle operating conditions are such that it would be prohibitive to place both power inverters 365A, 365B or 565A, 565B in standby mode. That is, the controller 364 or 564 determines whether the commanded torque at the output member could not be met if both power inverters were in standby mode. If it would be prohibitive to place both in standby mode, then the method 1000 proceeds to step 1022 to determine the lowest of the electrical power loss values determined in the method 1000. If, however, it would not be prohibitive to place both in standby mode, then the method 1000 first proceeds to step 1020, in which the controller 364 or 564 determines a fourth electrical power loss value of operating the first power inverter 365A or 565A in the standby mode, and the second power inverter 365B or 565B also in the standby mode. If the engine 326 or 526 is off, placing both power inverters 365A, 365B or 565A, 565B in standby mode would cause electric machines 360, 380 or 560, 580 to free-run and the vehicle to coast.

It should be noted that each of the determinations of the first, second, third, and optional fourth electrical power loss values in steps 1008, 1012, 1016, and 1020 include any power loss created by the hysteresis that occurs when changing the switch settings of the power inverters to the settings associated with the settings of the respective electrical power loss values, such as switching from active mode to standby mode and back to active mode (i.e., hysteresis associated with entering and exiting the respective modes of the inverters). Furthermore, the power loss values account for the reduced spin losses of any of the electric machines 360, 380, 560 or 580 having the associated power inverter 365A, 365B, 565A, 565B in the standby mode, if the electric machine is a permanent magnet machine and spin losses associated with power in the windings of the stator can be avoided with the inverter in the standby mode.

It should also be noted that steps 1006, 1008, 1010, 1012, 1014 and 1016 can be carried out in any order. After these steps are completed as described, the method 1000 proceeds to step 1022, in which the controller 364 or 564 determines which of the first, second, third, and optional fourth electrical power loss values is the lowest. If, as a result of steps 1010, 1014, or 1018, either of steps 1012, 1016, and 1020 are not carried out, then step 1022 will compare the first electrical power loss value with only those of the second, third, and fourth power loss value that have been determined.

Optionally, in step 1024, the controller 364 or 564 cab determine whether the lowest power loss value of step 1022 is lowest by at least a predetermined minimum amount. If the lowest power loss value is not lowest by at least a predetermined minimum amount, then the method 1000 can return to the start 1011, as the power savings are not considered to be great enough to warrant changing the current state of the electrical machines and power inverters. If, however, the power savings greater than the predetermined minimum amount can be achieved, the method 1000 proceeds to step 1026.

The controller 364 or 564 executes a control action in step 1026 to set the switches of the power inverters 365A, 365B or 565A, 565B to the respective modes (active or standby) corresponding with those resulting in the lowest electrical power loss value. For example, as illustrated with respect to FIG. 3, the control action may be sending a control signal to the inverter 110 to set the switches 182, 184, 186, 188, 190, 192 to the active or standby mode, as associated with the lowest electrical power loss value determined in step 1022. The method 1000 can then return to the start 1001. The controllers 364, 564 send a similar control signal to set the switches of the power inverters 365A, 365B or 565A, 565B

Again, the determinations as to whether inverter settings associated with a power loss value are prohibited under current operating conditions, and the determinations of the power loss values can be made either by referring to stored look-up tables or, alternatively, can be determined from real time calculations based on the sensed current vehicle operating requirements, requiring greater processing throughput than if look-up tables are used.

Accordingly, the method 1000 can be carried out by a controller on any hybrid powertrain that has at least two electric machines to advantageously reduce electrical power losses by placing a power inverter in a standby mode, thereby causing the electric machine connected to the power inverter to be in a free-running state.

While the best modes for carrying out the many aspects of the present teachings have been described in detail, those familiar with the art to which these teachings relate will recognize various alternative aspects for practicing the present teachings that are within the scope of the appended claims.

1. A method of controlling a hybrid powertrain comprising:
determining a first electrical power loss value of operating with power inverters of both a first electric machine and a second electric machine in an active mode;
determining at least one of:
a second electrical power loss value of operating with the power inverter of the first electric machine in the active mode and the power inverter of the second electric machine in a standby mode;
a third electrical power loss value of operating with the power inverter of the second electric machine in the active mode and the power inverter of the first electric machine in the standby mode;
determining the lowest of the first electrical power loss value and said at least one of the second electrical power loss value and the third electrical power loss value; and
executing a control action with respect to the power inverters via a controller to set the power inverters in the respective modes corresponding with the lowest of the first electrical power loss value and said at least one of the second and the third electrical power loss values.

2. The method of claim 1, further comprising:
determining a torque commanded of the first electric machine and a torque commanded of the second electric machine;
determining if either of the torque commanded of the first electric machine and the torque commanded of the second electric machine are less than a predetermined threshold torque;
wherein said determining the first electrical power loss value, said determining at least one of the second electrical power loss value and the third electrical power loss value, and said determining the lowest of said first electrical power loss value and said at least one of the second electrical power loss value and the third electrical power loss value is only if the torque commanded of the respective electric machine is less than the predetermined threshold torque.

3. The method of claim 1, further comprising:
determining whether the powertrain is operating in any of a predetermined set of operating modes in which the power inverters of both of the electric machines are in the active mode; and
wherein said determining the first electrical power loss value and at least one of the second and the third electrical power loss values is only if the powertrain is operating in any of the predetermined operating modes.

4. The method of claim 3, wherein the hybrid powertrain has an engine and an electrically-variable transmission; and wherein said predetermined set of operating modes includes an electric-only operating mode and an engine-off, regenerative operating mode.

5. The method of claim 3, wherein the hybrid powertrain has an engine; wherein the engine and the first electric machine are operatively connected to a first vehicle drive axle, and the second electric machine is operatively connected to a second vehicle drive axle; and
wherein said predetermined set of operating modes includes an electric-only operating mode, an engine-off, regenerative operating mode, and an engine-on, battery discharge/charge mode.

6. The method of claim 1, wherein the first electrical power loss value and said at least one of the second electrical power loss value and the third electrical power loss value each include a respective hysteresis loss of switching to the respective active or standby mode of the respective inverter.

7. The method of claim 1, wherein said executing a control action is only if the lowest of the first electrical power loss value and said at least one of the second electrical power loss value and the third electrical power loss value is lowest by at least a predetermined minimum amount.

8. The method of claim 1, further comprising:
determining whether vehicle operating parameters are prohibitive of operating the first electric machine in the standby mode;
determining whether vehicle operating parameters are prohibitive of operating the second electric machine in the standby mode;
wherein said determining at least one of the second electrical power loss value and the third electrical power loss value is determining both of the second electrical power loss value and the third electrical power loss value if the vehicle operating parameters are not prohibitive of operating the power inverter of the first electric machine in the standby mode and are not prohibitive of operating the power inverter of the second electric machine in the standby mode;
wherein said determining at least one of the second electrical power loss value and the third electrical power loss value is determining only the second electrical power loss value if the vehicle operating parameters are prohibitive of operating the power inverter of the first electric machine in the standby mode; and
wherein said determining at least one of the second electrical power loss value and the third electrical power loss value is determining only the third electrical power loss value if the vehicle operating parameters are prohibitive of operating the power inverter of the second electric machine in the standby mode.

9. The method of claim 1, wherein said determining the first electrical power loss value and said at least one of the second and the third electrical power loss value is based on real-time calculations using data indicative of current operating conditions.

10. The method of claim 1, wherein said determining the first electrical power loss value and said at least one of the second and the third electrical power loss value includes accessing a stored table of electrical power loss value values corresponding with predetermined operating parameters.

11. The method of claim 1, further comprising:
determining a fourth electrical power loss value of operating with the power inverter of the first electric machine in the standby mode and the power inverter of the second electric machine in the standby mode;
determining the lowest of the first electrical power loss value, said at least one of the second electrical power loss value and the third electrical power loss value, and the fourth electrical power loss value; and
executing a control action with respect to the power inverters via a controller to set the power inverters in the respective modes corresponding with the lowest of the first electrical power loss value, said at least one of the second and the third electrical power loss values, and the fourth electrical power loss value.

12. A method of controlling a hybrid powertrain comprising:
determining a lowest electrical power loss value for satisfying a predetermined output torque request for torque at an output member of the powertrain;
wherein the powertrain has a first electric machine with a first power inverter and a second electric machine with a second power inverter;
wherein said determining a lowest electrical power loss value includes determining electrical power loss values with both power inverters in an active mode, and at least one of:
with the first power inverter in an active mode and the second power inverter in a standby mode,
with the first power inverter in a standby mode and the second power inverter in an active mode;
with both the first power inverter and the second power inverter in a standby mode; and
executing a control action with respect to the power inverters via a controller to set the power inverters in the respective modes corresponding with the lowest electrical power loss value.

13. The method of claim 12, wherein said executing a control action is only if torque required from each of the electric machines with the power inverters set to the standby mode is less than a predetermined threshold torque.

14. The method of claim 12, further comprising:
determining whether vehicle operating parameters are prohibitive of operating the first power inverter in the standby mode;
determining whether vehicle operating parameters are prohibitive of operating the second power inverter in the standby mode;
wherein said determining a lowest electrical power loss value does not include determining an electrical power loss value with the first power inverter in a standby mode and the second power inverter in an active mode, nor with both the first power inverter and the second power inverter in a standby mode if the vehicle operating parameters are prohibitive of operating the first power inverter in the standby mode; and
wherein said determining a lowest electrical power loss value does not include determining an electrical power loss value with the first power inverter in an active mode and the second power inverter in a standby mode, nor with both the first power inverter and the second power inverter in a standby mode if the vehicle operating parameters are prohibitive of operating the power inverter of the second electric machine in the standby mode.

15. The method of claim 12, wherein said determining the lowest electrical power loss value includes accessing a stored table of electrical power loss value values corresponding with predetermined operating parameters.

16. The method of claim 12, further comprising:
determining whether the powertrain is operating in any of a predetermined set of operating modes in which the power inverters of both of the electric machines are in the active mode; and
wherein said determining the lowest electrical power loss value is only if the powertrain is operating in any of the predetermined operating modes.

17. The method of claim 16, wherein the hybrid powertrain has an engine and an electrically-variable transmission; and wherein said predetermined set of operating modes includes an electric-only operating mode and an engine-off, regenerative operating mode.

18. The method of claim 16, wherein the hybrid powertrain has an engine; wherein the engine and the first electric machine are operatively connected to a first vehicle drive axle, and the second electric machine is operatively connected to a second vehicle drive axle; and
wherein said predetermined set of operating modes includes an electric-only operating mode, an engine-off, regenerative operating mode, and an engine-on battery discharge/charge mode.

19. A hybrid powertrain comprising:
an engine;
a hybrid transmission having:
an input member operatively connected to the engine;
an output member;
a gearing arrangement operatively connecting the input member and the output member;
a battery module;
a first electric machine operatively connected to the gearing arrangement;
a first power inverter operatively connecting the battery module and the first electric machine;
a second electric machine operatively connected to the battery module;
a second power inverter operatively connecting the battery module and the second electric machine;
a controller operatively connected to the first and second power inverters and the output member; wherein the controller has a processor operable to execute a stored algorithm that:
determines a lowest electrical power loss value for satisfying a predetermined output torque request for torque provided by the powertrain; wherein said determining a lowest electrical power loss value includes determining electrical power loss values with both of the power inverters in an active mode, and at least one of:
with the first power inverter in an active mode and the second power inverter in a standby mode,
with the first power inverter in a standby mode and the second power inverter in an active mode;
with both the first power inverter and the second power inverter in a standby mode; and
executes a control action with respect to the power inverters to set the power inverters in the respective modes corresponding with the lowest electrical power loss value.
